(19) United States
(12) Patent Application Publication
(10) Pub. No.: US 2025/0376113 A1
(43) Pub. Date: Dec. 11, 2025

(54) METHOD OF OUTPUTTING A NOTIFICATION IN A DRIVER ENVIRONMENT, COMPUTER PROGRAM, COMPUTER-READABLE MEDIUM, CONTROL ARRANGEMENT, AND VEHICLE

(71) Applicant: Scania CV AB, Södertälje (SE)

(72) Inventors: Jonathan Adolfsson, Bandhagen (SE); Casper Johansson, Hägersten (SE)

(73) Assignee: Scania CV AB, Södertälje (SE)

(21) Appl. No.: 19/222,378

(22) Filed: May 29, 2025

(30) Foreign Application Priority Data
Jun. 5, 2024 (SE) 2450620-6

(51) Int. Cl. B60Q 9/00; B60T 7/12; B60T 8/171; B60T 8/172; B60T 8/58

(52) U.S. Cl. CPC B60Q 9/00; B60T 7/12; B60T 8/171; B60T 8/172; B60T 8/58; B60T 2201/04; B60T 2210/20; B60T 2220/04; B60T 2250/04; B60T 2270/402

(57) ABSTRACT

A method of outputting a notification in a driver environment of a vehicle is disclosed. The method comprises obtaining topographic data representative of the topography of an upcoming road segment, identifying an upcoming downhill slope in the upcoming road segment, obtaining, based on the topographic data, a speed estimate representative of a maximum allowable speed of the vehicle upon reaching the upcoming downhill slope for keeping the speed of the vehicle below a threshold speed in the upcoming downhill slope while using a predetermined braking amount of wheel brakes of the vehicle, and outputting a notification indicating the speed estimate in the driver environment before the vehicle reaches the upcoming downhill slope. The present disclosure further relates to a computer program, a computer-readable medium, a control arrangement, and a vehicle.

### TECHNICAL FIELD

The present disclosure relates to a method of outputting a notification in a driver environment of a vehicle. The present disclosure further relates to a computer program, a computer-readable medium, a control arrangement configured to output a notification in a driver environment of a vehicle, as well as a vehicle comprising a control arrangement.

### BACKGROUND

Wheeled vehicles normally comprise wheel brakes controllable to brake the vehicle, for example via a brake pedal arranged in a driver environment of the vehicle, and/or via an at least partially autonomous braking system. Wheel brakes are essential for vehicle safety, allowing for controlled deceleration and full stops. Typically, vehicles use either disc brakes, which involve a rotor and callipers, or drum brakes, which use a drum and a set of brake shoes. When a brake pedal is pressed, hydraulic or pneumatic fluid engages these components, generating friction to slow down the rotation of the wheels and accordingly also to slow down the vehicle.

One critical aspect of brake performance is temperature. The friction between brake pads and rotors or brake shoes and drums generates heat, which is dissipated into the surrounding air. However, during intense or prolonged braking, such as when the vehicle is descending a steep downhill slope, the temperature can rise significantly, leading to a condition known as brake fade. Brake fade is the reduction in stopping power that occurs when the brake components overheat. Elevated temperatures can also cause the brake pad material to degrade, which can inflict premature wear of the wheel brakes.

Auxiliary brakes can be used in vehicles to serve as secondary braking systems that work alongside the conventional wheel brakes. Auxiliary brakes normally generate resistance within the engine or driveline to slow down the vehicle. Common types include engine brakes, which adjust engine valve timing, exhaust brakes that restrict the flow of exhaust gases to create back pressure, and hydraulic or electromagnetic retarders or machines, which create drag in the driveline of the vehicle. These systems are useful for slowing down on steep grades, helping to prevent brake overheating and extending the lifespan of the wheel brakes. However, they are not meant for complete stops and should be used in conjunction with the wheel brakes for optimal safety and performance.

Moreover, some vehicles are equipped with a regenerative braking system that can recapture kinetic energy, which would otherwise be lost as heat during braking, and convert it into useful energy. Regenerative braking systems operate in various ways. In electric and hybrid vehicles, these systems often use an electric motor as a generator during braking. When the driver presses the brake pedal, the motor switches to generator mode, converting the kinetic energy from the wheels into electrical energy, which is then stored in a propulsion battery of the vehicle. Some heavy-duty vehicles comprise hydraulic regenerative braking systems. These systems use hydraulic pumps and accumulators to capture and store energy. During braking, the kinetic energy is used to pressurize a hydraulic fluid, which is then stored and can be released to assist in acceleration later. Another approach involves flywheel energy storage systems, which store energy mechanically in a rotating flywheel. When braking, the vehicle's kinetic energy spins the flywheel, and this energy can be released to aid in acceleration. Although less common in consumer vehicles, flywheel systems are sometimes used in public transportation and racing applications.

Regenerative braking not only enhances energy efficiency but also reduces wear on traditional braking components, leading to lower maintenance costs and increased longevity of the brake system. Additionally, by recapturing energy, these systems contribute to extended driving range in electric and hybrid vehicles, making them a crucial component in modern, sustainable vehicle design. However, like auxiliary brakes, regenerative braking system are normally not meant for complete stops and are normally designed to provide an available braking power that is lower than the required braking power in many driving situations. Therefore, regenerative braking systems are to be used in conjunction with the wheel brakes for optimal safety and performance, like the auxiliary braking systems referred to above.

### SUMMARY

It is an object of the present invention to overcome, or at least alleviate, at least some of the above-mentioned problems and drawbacks. The object is achieved by the subject-matter of the appended independent claim(s).

According to a first aspect of the present disclosure, the object is achieved by a method of outputting a notification in a driver environment of a vehicle, wherein the method is performed by a control arrangement, and wherein the vehicle comprises wheel brakes,

wherein the method comprises the steps of, when the vehicle is travelling on a road:
obtaining topographic data representative of the topography of an upcoming road segment of the road,
identifying an upcoming downhill slope in the upcoming road segment,
obtaining, based on the topographic data, a speed estimate representative of a maximum allowable speed of the vehicle upon reaching the upcoming downhill slope for keeping the speed of the vehicle below a threshold speed in the upcoming downhill slope while using a predetermined braking amount of the wheel brakes, and
outputting a notification indicating the speed estimate in the driver environment before the vehicle reaches the upcoming downhill slope.

In this manner, conditions are provided for adapting the speed of the vehicle to the maximum allowable speed before the vehicle reaches the upcoming downhill slope, thereby allowing for only the predetermined braking amount of the wheel brakes to be used in the upcoming downhill slope while keeping the speed of the vehicle below the threshold speed. Thereby, the method provides conditions for avoiding excessive wear of the wheel brakes and excessive temperature development in the wheel brakes. As a further result thereof, a method is provided having conditions for improving the operational safety of the vehicle.

Moreover, the method allows for a higher average speed as compared to if the speed estimate was set to represent a maximum allowable speed of the vehicle upon reaching the upcoming downhill slope for keeping the speed of the vehicle below the threshold speed in the upcoming downhill slope without using the wheel brakes.

In other words, a method is provided capable of reducing wear of the wheel brakes, and occurrences of excessive temperature development in the wheel brakes, while being able to ensure maintenance of a certain average speed of the vehicle.

Accordingly, a method is provided overcoming, or at least alleviating, at least some of the above-mentioned problems and drawbacks. As a result, the above-mentioned object is achieved.

Optionally, the predetermined braking amount of the wheel brakes is set to limit at least one of wear of the wheel brakes and temperature development in the wheel brakes obtained in the upcoming downhill slope. Thereby, avoidance of excessive wear of the wheel brakes and excessive temperature development in the wheel brakes can be further ensured.

Optionally, the vehicle comprises a wheel brake system comprising the wheel brakes, and wherein the vehicle comprises an additional system controllable to brake the vehicle, the additional system being separate from the wheel brake system, and wherein the step of obtaining the speed estimate comprises:
obtaining the speed estimate based on an available braking power of the additional system.

Thereby, an adaptive method is provided capable of reducing wear of the wheel brakes, and occurrences of excessive temperature development in the wheel brakes, while being able to maintain a certain average speed of the vehicle.

Optionally, the step of obtaining the speed estimate comprises:
obtaining the speed estimate based on an inclination of the upcoming downhill slope.

Thereby, an adaptive method is provided capable of outputting more accurate notifications so as to allow for reduced wear of the wheel brakes, and occurrences of excessive temperature development in the wheel brakes, while being able to ensure maintenance of a certain average speed of the vehicle.

Optionally, wherein the step of obtaining the speed estimate comprises:
obtaining the speed estimate based on a length of the upcoming downhill slope.

Thereby, an adaptive method is provided capable of outputting more accurate notifications so as to allow for reduced wear of the wheel brakes, and occurrences of excessive temperature development in the wheel brakes, while being able to ensure maintenance of a certain average speed of the vehicle.

Optionally, the method comprises:
outputting the notification when the vehicle is a predetermined time or a predetermined distance from the upcoming downhill slope.

Thereby, conditions are provided for allowing a smooth and controlled adjustment of a current vehicle speed to the maximum allowable speed before the vehicle reaches the upcoming downhill slope.

Optionally, the method comprises:
adapting the predetermined time or the predetermined distance based on a difference between a current speed of the vehicle and the speed estimate.

Thereby, improved conditions are provided for allowing smooth and controlled adjustments of a current vehicle speed to the maximum allowable speed before the vehicle reaches the upcoming downhill slope.

Optionally, the method comprises:
adapting the predetermined braking amount based on input from a user interface assembly of the vehicle.

Thereby, a method is provided allowing a user to determine/set the predetermined braking amount, and thus to determine/set a preferred usage of the wheel brakes in upcoming downhill slopes.

Optionally, the method comprises:
setting the threshold speed based on a regulatory speed limit of the upcoming downhill slope.

Thereby, an adaptive method is provided capable of reducing wear of the wheel brakes, and occurrences of excessive temperature development in the wheel brakes, while being able to ensure that the regulatory speed limit is not surpassed in the upcoming downhill slope.

Optionally, the step of outputting the notification comprises:
displaying the notification.

Thereby, the notification can be output in a clear and concise manner to inform a driver of the vehicle about the speed estimate before the vehicle reaches the upcoming downhill slope.

Optionally, the method comprises:
reducing the speed of the vehicle to the maximum allowable speed before the vehicle reaches the upcoming downhill slope.

Thereby, an adaptive method is provided capable of reducing wear of the wheel brakes, and occurrences of excessive temperature development in the wheel brakes, while being able to ensure maintenance of a certain average speed of the vehicle.

The step of reducing the speed of the vehicle to the maximum allowable speed may be performed by reducing a set speed of an adaptive cruise control arrangement of the vehicle.

Optionally, the method comprises:
generating a speed reduction prompt based on the speed estimate, and
outputting the speed reduction prompt in the driver environment of the vehicle, and
   wherein the step of reducing the speed of the vehicle is contingent upon receiving a confirmation of the speed reduction prompt via a user interface assembly of the vehicle.

Thereby, a method is provided allowing a driver to select whether or not to reduce the speed of the vehicle to the maximum allowable speed before the vehicle reaches the upcoming downhill slope.

Optionally, the outputted speed reduction prompt comprises the notification. Thereby, the speed reduction prompt, including the notification, can be outputted in a clear and concise manner.

According to a second aspect of the present disclosure, the object is achieved by a computer program comprising instructions to cause the control arrangement according to the second aspect of the present disclosure to execute the steps of the method according to some embodiments of the first aspect of the present disclosure. Since the computer program comprises instructions to cause the control arrangement to carry out the method according to some embodiments described herein, a computer program is provided which provides conditions for overcoming, or at least alleviating, at least some of the above-mentioned drawbacks. As a result, the above-mentioned object is achieved.

According to a third aspect of the present disclosure, the object is achieved by a computer-readable medium having stored thereon the computer program according to the second aspect of the present disclosure. Since the computer-readable medium comprises instructions to cause the control arrangement to carry out the method according to some embodiments described herein, a computer-readable medium is provided which provides conditions for overcoming, or at least alleviating, at least some of the above-mentioned drawbacks. As a result, the above-mentioned object is achieved.

According to a fourth aspect of the present disclosure, the object is achieved by a control arrangement configured to output a notification in a driver environment of a vehicle, wherein the vehicle comprises wheel brakes,

wherein the control arrangement is configured to, when the vehicle is travelling on a road:
obtain topographic data representative of the topography of an upcoming road segment of the road,
identify an upcoming downhill slope in the upcoming road segment,
obtain, based on the topographic data, a speed estimate representative of a maximum allowable speed of the vehicle upon reaching the upcoming downhill slope for keeping the speed of the vehicle below a threshold speed in the upcoming downhill slope while using a predetermined braking amount of the wheel brakes, and
output a notification indicating the speed estimate in the driver environment before the vehicle reaches the upcoming downhill slope.

In this manner, conditions are provided for adapting the speed of the vehicle to the maximum allowable speed before the vehicle reaches the upcoming downhill slope, thereby allowing for only the predetermined braking amount of the wheel brakes to be used in the upcoming downhill slope while keeping the speed of the vehicle below the threshold speed. Thereby, the control arrangement provides conditions for avoiding excessive wear of the wheel brakes and excessive temperature development in the wheel brakes. As a further result thereof, a control arrangement is provided having conditions for improving the operational safety of the vehicle.

Moreover, the control arrangement allows for a higher average speed as compared to if the speed estimate was set to represent a maximum allowable speed of the vehicle upon reaching the upcoming downhill slope for keeping the speed of the vehicle below the threshold speed in the upcoming downhill slope without using the wheel brakes.

In other words, a control arrangement is provided capable of reducing wear of the wheel brakes, and occurrences of excessive temperature development in the wheel brakes, while being able to ensure maintenance of a certain average speed of the vehicle.

Accordingly, a control arrangement is provided overcoming, or at least alleviating, at least some of the above-mentioned problems and drawbacks. As a result, the above-mentioned object is achieved.

It will be appreciated that the various embodiments described for the method are all combinable with the control arrangement as described herein. That is, the control arrangement according to the fourth aspect of the invention may be configured to perform any one of the method steps of the method according to the first aspect of the invention.

According to a fifth aspect of the present disclosure, the object is achieved by a vehicle comprising wheel brakes and a control arrangement according to the fourth aspect of the present disclosure. Since the vehicle comprises a control arrangement according to the fourth aspect of the present disclosure, a vehicle is provided overcoming, or at least alleviating, at least some of the above-mentioned problems and drawbacks. As a result, the above-mentioned object is achieved.

Optionally, the vehicle is a heavy road vehicle, such as a truck or a bus. Thereby, a heavy road vehicle is provided having at least some of the above-mentioned advantages.

Further features of, and advantages with, the present invention will become apparent when studying the appended claims and the following detailed description.

### BRIEF DESCRIPTION OF THE DRAWINGS

Various aspects of the present disclosure, including its particular features and advantages, will be readily understood from the example embodiments discussed in the following detailed description and the accompanying drawings, in which:

FIG. 1 schematically illustrates a vehicle according to some embodiments,

FIG. 2 illustrates the vehicle illustrated in FIG. 1 as travelling on a road,

FIG. 3 schematically illustrates a method of outputting a notification in a driver environment of a vehicle, and

FIG. 4 illustrates a computer-readable medium.

### DETAILED DESCRIPTION

Aspects of the present disclosure will now be described more fully. Like reference signs refer to like elements throughout. Well-known functions or constructions will not necessarily be described in detail for brevity and/or clarity.

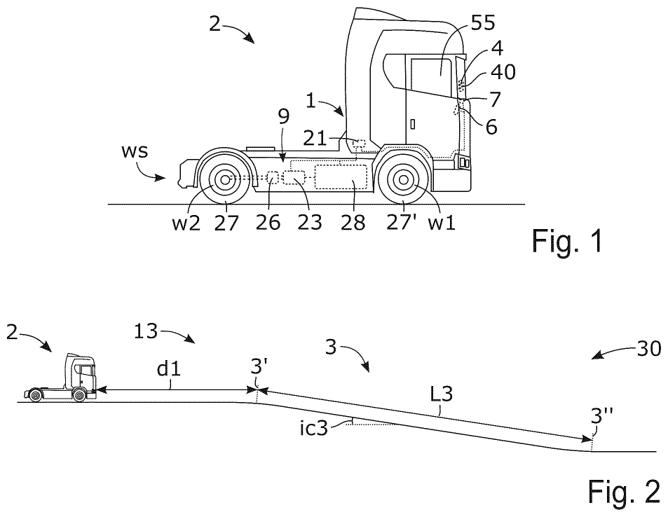

FIG. 1 schematically illustrates a vehicle 2 according to some embodiments. According to the illustrated embodiments, the vehicle 2 is a truck, i.e., a type of heavy road vehicle, as well as a type of heavy commercial vehicle. According to further embodiments, the vehicle 2, as referred to herein, may be another type of heavy or lighter type of manned or unmanned vehicle for land-based propulsion such as a lorry, a bus, a construction vehicle, a tractor, a car, or the like.

The vehicle 2 comprises a transmission 26 and a power source 23. The power source 23 is operably connected to driven wheels 27 of the vehicle 2 via the transmission 26. In other words, the power source 23 is configured to provide motive power to the vehicle 2 via the transmission 26 and the driven wheels 27 of the vehicle 2. According to the illustrated embodiments, the vehicle 2 comprises two driven wheels 27 which constitute rear-wheels of the vehicle 2. The vehicle 2 further comprises two non-driven wheels 27′, which according to the illustrated embodiments constitute front-wheels of the vehicle 2. However, according to further embodiments, the vehicle 2 may comprise another configuration of driven and non-driven wheels.

According to the illustrated embodiments, the power source 23 is an electric propulsion machine. Moreover, according to the illustrated embodiments, the vehicle 2 is a pure electric vehicle comprising the electric propulsion machine as the only means of providing motive power to the vehicle 2 and no internal combustion engine. However, according to further embodiments, the vehicle 2 may be a so called hybrid electric vehicle comprising an internal combustion engine in addition to the electric propulsion machine for providing motive power to the vehicle 2.

According to the embodiments illustrated in FIG. 1, the vehicle 2 comprises an electrical energy storage system 28 configured to store electrical energy. The power source 23 is configured to operate using electricity from the electrical energy storage system 28. The electrical energy storage system 28 may comprise a number of battery packs each comprising a number of rechargeable battery cells, such as lithium-ion battery cells, lithium polymer battery cells, lithium iron phosphate battery cells, or the like. As an alternative, or in addition, the vehicle 2 may comprise a pressure tank, such as a cryogenic pressure tank, configured to store hydrogen gas. According to such embodiments, the vehicle 2 may comprise one or more fuel cells configured to generate electricity through a chemical reaction between hydrogen from the pressure tank and oxygen. The power source 23 of the vehicle 2 may be configured to operate using electricity from such one or more fuel cells.

Moreover, according to some further embodiments of the present disclosure, the power source 23, as referred to herein, may be an internal combustion engine. The internal combustion engine may be a diesel engine, i.e. a type of compression ignition engine. The internal combustion engine may thus be configured to operate on diesel or a diesel-like fuel, such as biodiesel, biomass to liquid (BTL), or gas to liquid (GTL) diesel. Diesel-like fuels, such as biodiesel, can be obtained from renewable sources such as vegetable oil which mainly comprises fatty acid methyl esters (FAME). Diesel-like fuels can be produced from many types of oils, such as rapeseed oil (rapeseed methyl ester, RME) and soybean oil (soy methyl ester, SME).

According to further embodiments, the internal combustion engine may be an Otto engine with a spark-ignition device, wherein the Otto engine is configured to run on petrol, alcohol, a gaseous fuel, or combinations thereof. Alcohol, such as ethanol, can be derived from renewable biomass.

The gaseous fuel may also be referred to as fuel gas and may encompass any type of fuel that under ordinary ambient temperature and pressure conditions are gaseous and which can be stored at pressure in a pressure tank and can be combusted in an internal combustion engine to produce useful work. Examples of such gaseous fuels are compressed natural gas (CNG), liquified natural gas (LNG), Liquefied Petroleum Gas (LPG), Hydrogen (H2), Biogas, and Syngas. Many gaseous fuels can be derived from renewable sources, such as from renewable biomass. According to embodiments herein, the internal combustion engine may be a four-stroke internal combustion engine.

As indicated in FIG. 1, the vehicle 2 comprises wheel brakes w1, w2 controllable to brake the vehicle 2. The wheel brakes w1, w2 are comprised in a wheel brake system ws of the vehicle 2 and are controllable to brake the vehicle 2 by braking rotation of the wheels 27′, 27 of the vehicle 2. The wheel brakes w1, w2 may comprise friction brake arrangements, such as drum brakes, disc brakes, or a combination thereof. Drum brakes normally comprise a cylinder-shaped part called a brake drum and a set of shoes or pads controllable to be pressed against the cylinder-shaped part to create friction therebetween for braking rotation of the wheels. Disc brakes normally comprise a disc and a set of pads controllable to be pressed against the disc to create friction therebetween for braking rotation of the wheels.

According to the illustrated embodiments, the vehicle 2 comprises an additional system 9 controllable to brake the vehicle 2, wherein the additional system 9 is separate from the wheel brake system ws. According to the embodiments illustrated in FIG. 1, the additional system 9 comprises the power source 23 of the vehicle 2. As explained above, according to the illustrated embodiments, the power source 23 is an electric propulsion machine. In other words, in these embodiments, the additional system 9 is controllable to brake the vehicle 2 via the driven wheels 27 by operating the electric propulsion machine as a generator. The electricity generated during braking can be stored in the electrical energy storage system 28 for subsequent use. Thus, according to the illustrated embodiments, the additional system 9 can also be referred to as a regenerative braking system of the vehicle 2. According to further embodiments, the additional system 9, as referred to herein, may be another type of regenerative braking system, or an auxiliary braking system, such as an engine brake, exhaust brake, or a hydraulic or electromagnetic retarder.

In FIG. 1, a driver environment 55 of the vehicle 2 is indicated. The term “driver environment 55” refers to the area within the vehicle 2 where a driver operates and controls the vehicle 2. The driver environment 55 typically includes the driver's seat, steering wheel, pedals, dashboard, and other control interfaces and displays that the driver may use to manage the functions of the vehicle 2.

The vehicle 2 comprises a control arrangement 21. As is further explained herein, the control arrangement 21 is configured to output a notification 4 in the driver environment 55 of the vehicle 2.

FIG. 2 illustrates the vehicle 2 illustrated in FIG. 1 as travelling on a road 30. Below, simultaneous reference is made to FIG. 1 and FIG. 2, if not indicated otherwise.

The control arrangement 21 is configured to obtain topographic data representative of the topography of an upcoming road segment 13 of the road 30. The control arrangement 21 may be configured to obtain the topographic data from map data containing topographic information about the road 30. The map data may be stored in an onboard system of the vehicle 2 and/or may be received from an external sender. The onboard system may for example be an onboard navigation system.

The vehicle 2 may comprise a vehicle positioning device configured to provide a current position estimate of the vehicle 2. Such a vehicle positioning device may for example utilize a space-based satellite navigation system such as a Global Positioning System (GPS), The Russian GLObal NAvigation Satellite System (GLONASS), European Union Galileo positioning system, Chinese Compass navigation system, or Indian Regional Navigational Satellite System.

The control arrangement 21 may be configured to, when the vehicle 2 is travelling on a road 30, obtain the topographic data representative of the topography of an upcoming road segment 13 of the road 30 by comparing the current position estimate of the vehicle 2 and the map data.

As an alternative, or in addition, the control arrangement 21 may be configured to, when the vehicle 2 is travelling on a road 30, obtain the topographic data representative of the topography of an upcoming road segment 13 of the road 30 based on data from an onboard sensor assembly, wherein the onboard sensor assembly is configured to monitor a driving environment in front of the vehicle 2. Such a sensor assembly may comprise one or more of an image capturing device, such as a camera, a LiDAR (Light Detection and Ranging) sensor, and a radar (Radio Detection and Ranging) sensor.

An image capturing device works by capturing visual data in the form of images or videos. This allows the control arrangement 21 to identify and interpret various aspects of the driving environment in front of the vehicle 2, such as elevation of the upcoming road segment 13 of the road 30. LiDAR sensors function by emitting pulsed laser light and measuring the time it takes for the light to bounce back after hitting an object. This data can be used to create accurate, three-dimensional information about the surrounding environment, including elevation of the upcoming road segment 13 of the road 30. Radar sensors emits radio waves that bounce off the surface of the road and other objects ahead. By analysing the reflected signals, the radar can detect changes in the elevation and contours of the road surface. This data can thus provide real-time information about the topography of the upcoming road segment 13 of the road 3.

The control arrangement 21 is further configured to identify an upcoming downhill slope 3 in the upcoming road segment 13. The control arrangement 21 may be configured to identify the upcoming downhill slope 3 by analysing the above mentioned topographic data being representative of the topography of an upcoming road segment 13 of the road 30.

Moreover, according to embodiments herein, the control arrangement 21 is configured to obtain, based on the topographic data, a speed estimate representative of a maximum allowable speed of the vehicle 2 upon reaching the upcoming downhill slope 3 for keeping the speed of the vehicle 2 below a threshold speed in the upcoming downhill slope 3 while using a predetermined braking amount of the wheel brakes w1, w2.

As is further explained below, the predetermined braking amount of the wheel brakes w1, w2 may be set to limit at least one of wear of the wheel brakes w1, w2 and temperature development in the wheel brakes w1, w2 obtained in the upcoming downhill slope 3. The predetermined braking amount may be preprogrammed into the control arrangement 21, and/or may, as is further explained herein, be selectable via user interface assembly 6 of the vehicle 2. The predetermined braking amount may be represented by, or may constitute, a predetermined braking power, and/or a predetermined braking energy, for keeping the speed of the vehicle 2 below a threshold speed in the upcoming downhill slope 3. According to some embodiments, the predetermined braking amount of the wheel brakes w1, w2 may be set to limit the temperature development in the wheel brakes w1, w2 obtained in the upcoming downhill slope 3 such that the temperature of the wheel brakes w1, w2 remains below a threshold temperature in the upcoming downhill slope 3 if the use of the wheel brakes w1, w2 is limited to the predetermined braking amount. Purely as an example, the threshold temperature may be within the range of 200-350 degrees Celsius.

The control arrangement 21 may be configured to obtain the speed estimate based on an inclination ic3 of the upcoming downhill slope 3. In such embodiments, the control arrangement 21 may be configured to reduce the speed estimate with increasing inclinations ic3 and vice versa. This is because increasing inclinations ic3 of downhill slopes 3 typically increase the braking need of a vehicle 2. As an alternative, or in addition, the control arrangement 21 may be configured to obtain the speed estimate based on a length L3 of the upcoming downhill slope 3. In such embodiments, the control arrangement 21 may be configured to reduce the speed estimate with increasing lengths L3 of upcoming downhill slopes 3 and vice versa. This is because increasing lengths L3 of downhill slopes 3 typically increase the braking need of a vehicle 2.

Furthermore, according to some embodiments, the control arrangement 21 may be configured to obtain the speed estimate based on an available braking power of the additional system 9. In such embodiments, the control arrangement 21 may be configured to reduce the speed estimate with reducing available braking power of the additional system 9 and vice versa. As an alternative, or in addition, the control arrangement 21 may be configured to obtain the speed estimate based on one or more of a curvature of the upcoming road segment 13 of the road 30, a current weight estimate of the vehicle 2, current weather conditions, such as wind conditions, and a rolling resistance estimate of the vehicle 2. The curvature of the upcoming road segment 13 of the road 30 may be obtained from the above-mentioned map data. As an alternative, or in addition, the curvature of the upcoming road segment 13 of the road 30 may be obtained based on data from the above-mentioned onboard sensor assembly. The curvature of road segments leads to cornering force resistance on the vehicle 2, and the control arrangement 21 may be configured to adapt the speed estimate accordingly.

The control arrangement 21 is configured to output a notification 4 indicating the speed estimate in the driver environment 55 before the vehicle 2 reaches the upcoming downhill slope 3. In this manner, conditions are provided for adapting the speed of the vehicle 2 to the maximum allowable speed before the vehicle 2 reaches the upcoming downhill slope 3 so as to allow for only the predetermined braking amount of the wheel brakes w1, w2 to be used in the upcoming downhill slope 3 while keeping the speed of the vehicle 2 below the threshold speed. In other words, in this manner, the control arrangement 21 provides conditions for avoiding excessive wear of the wheel brakes w1, w2 and excessive temperature development in the wheel brakes w1, w2. As a further result thereof, a control arrangement 21 is provided having conditions for improving the operational safety of the vehicle 2.

Moreover, the control arrangement 21 allows for a higher average speed as compared to if the speed estimate was set to represent a maximum allowable speed of the vehicle 2 upon reaching the upcoming downhill slope 3 for keeping the speed of the vehicle 2 below the threshold speed in the upcoming downhill slope 3 without using the wheel brakes w1, w2.

In other words, the control performed by the control arrangement 21 can reduce wear of the wheel brakes w1, w2, and occurrences of excessive temperature development in the wheel brakes w1, w2, while being able to ensure maintenance of a certain average speed of the vehicle 2.

According to the illustrated embodiments, the control arrangement 21 is configured to output the notification 4 by displaying the notification 4 using a head-up display (HUD) assembly 7 of the vehicle 2. The head-up display assembly 7 is a type of display that projects information onto a windshield pf the vehicle 2, or a dedicated screen, within the driver's line of sight. This allows drivers to access the displayed information without diverting their eyes from the road. The head-up display assembly 7 uses a combination of light projection, mirrors, and optical elements to create a visible image that appears to float above the dashboard of the vehicle 2 thereby minimizing the need for drivers to look away from the road 30.

The control arrangement 21 may, as an alternative, or in addition, be configured to output the notification 4 indicating the speed estimate in the driver environment 55 in another manner, such as by using another type of display, and/or by using a speaker configured to output an audible notification in the driver environment 55 of the vehicle 2.

Each of the speed estimate and the maximum allowable speed, as referred to herein, may be represented by a number given in a speed magnitude unit, such as kilometres per hour (km/h), miles per hour (mph), or meters per second (m/s). In other words, the notification 4 indicating the speed estimate may be outputted in the form of a number indicating the maximum allowable speed in a speed magnitude unit, such as kilometres per hour (km/h), miles per hour (mph), or meters per second (m/s).

According to the illustrated embodiments, the control arrangement 21 is configured to output the notification 4 when the vehicle 2 is a predetermined time or a predetermined distance d1 from the upcoming downhill slope 3. The predetermined time or predetermined distance d1 may be set such that the speed of the vehicle 2 can be adjusted to the maximum allowable speed before the vehicle 2 reaches the upcoming downhill slope 3, in a safe, controlled, and convenient manner. According to some embodiments, the control arrangement 21 may be configured to adapt the predetermined time or the predetermined distance d1 based on a difference between a current speed of the vehicle 2 and the speed estimate. According to such embodiments, the predetermined time or the predetermined distance d1 may be increased with increasing differences between the current speed of the vehicle 2 and the speed estimate and may be reduced with reducing differences between the current speed of the vehicle 2 and the speed estimate.

As mentioned, the control arrangement 21 may be configured to adapt the predetermined braking amount based on input from a user interface assembly 6 of the vehicle 2. This allows users to determine/set the predetermined braking amount, and thus also to determine/set the preferred use of the wheel brakes w1, w2 in upcoming downhill slopes 3. The user interface assembly 6 of the vehicle 2 may comprise one or more of a touch sensitive screen, a button, a knob, a lever, a microphone, or the like.

According to some embodiments, the control arrangement 21 is configured to set the threshold speed based on a regulatory speed limit of the upcoming downhill slope 3. In this manner, it can be ensured that the regulatory speed limit is not exceeded in the upcoming downhill slope 3 while only using the predetermined braking amount in the upcoming downhill slope 3. The regulatory speed limit of the upcoming downhill slope 3 may be inputted using the above-mentioned map data, and/or a speed sign recognition unit utilizing data from an image capturing device of the above-mentioned onboard sensor assembly of the vehicle 2.

According to some embodiments, the control arrangement 21 is configured to reduce the speed of the vehicle 2 to the maximum allowable speed before the vehicle 2 reaches the upcoming downhill slope 3. In these embodiments, the control arrangement 21, as referred to herein, may be configured to communicate with, or form part of, an adaptive cruise control arrangement of the vehicle 2. In such embodiments, the control arrangement 21 may be configured to reduce the speed of the vehicle 2 by reducing a set speed of the vehicle 2.

According to the illustrated embodiments, the control arrangement 21 is further configured to generate a speed reduction prompt 40 based on the speed estimate, and output the speed reduction prompt 40 in the driver environment 55 of the vehicle 2. The speed reduction prompt 40 may be generated based on a difference between a current speed of the vehicle 2 and the speed estimate. According to the embodiments illustrated in FIG. 1, the control arrangement 21 is configured to output the speed reduction prompt 40 by displaying the speed reduction prompt 40 using the head-up display assembly 7. The control arrangement 21 may, as an alternative, or in addition, be configured to output the speed reduction prompt 40 in the driver environment 55 in another manner, such as by using another type of display, and/or by using a speaker configured to output an audible notification in the driver environment 55 of the vehicle 2. According to the embodiments illustrated in FIG. 1, the outputted speed reduction prompt 40 comprises the notification 4, i.e., the notification 4 indicating the speed estimate.

In these embodiments, the control arrangement 21 is configured to reduce the speed of the vehicle 2 to the maximum allowable speed following the receipt of a confirmation of the speed reduction prompt 40 via the user interface assembly 6 of the vehicle 2. In other words, in these embodiments, the reduction of the speed of the vehicle 2 to the maximum allowable speed before the vehicle 2 reaches the upcoming downhill slope 3 is contingent upon receiving the confirmation of the speed reduction prompt 40 via the user interface assembly 6 of the vehicle 2.

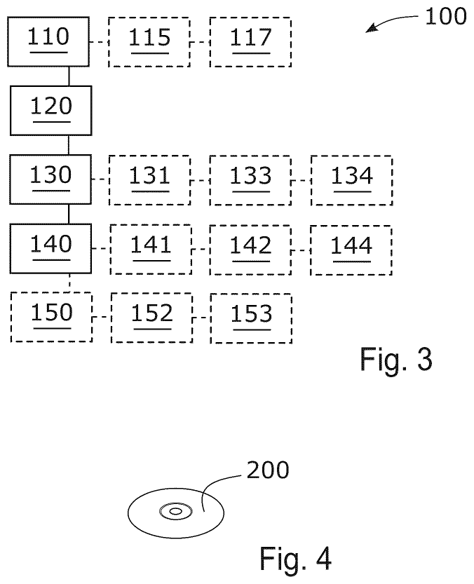

FIG. 3 schematically illustrates a method 100 of outputting a notification in a driver environment of a vehicle. The vehicle may be a vehicle 2 according to the embodiments explained with reference to FIG. 1 and FIG. 2. Therefore, below, simultaneous reference is made to FIG. 1-FIG. 3, if not indicated otherwise.

The method 100 is a method of outputting a notification 4 in a driver environment 55 of a vehicle 2, wherein the method 100 is performed by a control arrangement 21, and wherein the vehicle 2 comprises wheel brakes w1, w2. The method 100 comprises the steps of, when the vehicle 2 is travelling on a road 30:
obtaining 110 topographic data representative of the topography of an upcoming road segment 13 of the road 30,
identifying 120 an upcoming downhill slope 3 in the upcoming road segment 13,
obtaining 130, based on the topographic data, a speed estimate representative of a maximum allowable speed of the vehicle 2 upon reaching the upcoming downhill slope 3 for keeping the speed of the vehicle 2 below a threshold speed in the upcoming downhill slope 3 while using a predetermined braking amount of the wheel brakes w1, w2, and
outputting 140 a notification 4 indicating the speed estimate in the driver environment 55 before the vehicle 2 reaches the upcoming downhill slope 3.

According to some embodiments, the predetermined braking amount of the wheel brakes w1, w2 is set to limit at least one of wear of the wheel brakes w1, w2 and temperature development in the wheel brakes w1, w2 obtained in the upcoming downhill slope 3.

Furthermore, according to some embodiments, the vehicle 2 comprises a wheel brake system ws comprising the wheel brakes w1, w2, and wherein the vehicle 2 comprises an additional system 9 controllable to brake the vehicle 2, the additional system 9 being separate from the wheel brake system ws. According to such embodiments, the step of obtaining 130 the speed estimate comprises:
obtaining 131 the speed estimate based on an available braking power of the additional system 9.

The speed estimate may be obtained based on an available braking power of the additional system 9 such that reducing speed estimates are obtained with reducing available braking power of the additional system 9, and vice versa.

Moreover, as indicated in FIG. 3, the step of obtaining 130 the speed estimate may comprise:
obtaining 133 the speed estimate based on an inclination ic3 of the upcoming downhill slope 3.

The speed estimate may be obtained based on the inclination ic3 of upcoming downhill slopes 3 such that reducing speed estimates are obtained with increasing inclinations ic3 upcoming downhill slopes 3, and vice versa.

Furthermore, as indicated in FIG. 3, the step of obtaining 130 the speed estimate may comprise:
obtaining 134 the speed estimate based on a length L3 of the upcoming downhill slope 3.

The speed estimate may be obtained based on the length L3 of upcoming downhill slopes 3 such that reducing speed estimates are obtained with increasing lengths L3 upcoming downhill slopes 3, and vice versa.

Moreover, as indicated in FIG. 3, according to some embodiments, the method 100 may comprise:
outputting 142 the notification 4 when the vehicle 2 is a predetermined time or a predetermined distance d1 from the upcoming downhill slope 3.

As indicated in FIG. 3, according to some embodiments, the method 100 may comprise:
adapting 141 the predetermined time or the predetermined distance d1 based on a difference between a current speed of the vehicle 2 and the speed estimate.

The predetermined time or the predetermined distance d1 may be adapted such that the predetermined time or the predetermined distance d1 is increased with increasing differences between the current speed of the vehicle 2 and the speed estimate, and is reduced with reducing differences between the current speed of the vehicle 2 and the speed estimate.

Moreover, as indicated in FIG. 3, the method 100 may comprise:
adapting 115 the predetermined braking amount based on input from a user interface assembly 6 of the vehicle 2.

Furthermore, according to some embodiments, the method 100 may comprise:
setting 117 the threshold speed based on a regulatory speed limit of the upcoming downhill slope 3.

The regulatory speed limit of the upcoming downhill slope 3 may be inputted using map data, and/or a speed sign recognition unit utilizing data from an image capturing device of an onboard sensor assembly of the vehicle 2.

According to some embodiments, the step of outputting 140 the notification 4 comprises:
displaying 144 the notification 4.

As indicated in FIG. 3, according to some embodiments, the method 100 comprises:
reducing 153 the speed of the vehicle 2 to the maximum allowable speed before the vehicle 2 reaches the upcoming downhill slope 3.

The step of reducing 153 the speed of the vehicle 2 to the maximum allowable speed may be performed by reducing a set speed of an adaptive cruise control arrangement of the vehicle 2.

Furthermore, as indicated in FIG. 3, according to some embodiments, the method 100 comprises:
generating 150 a speed reduction prompt 40 based on the speed estimate, and
outputting 152 the speed reduction prompt 40 in the driver environment 55 of the vehicle 2, and
wherein the step of reducing 153 the speed of the vehicle 2 is contingent upon receiving a confirmation of the speed reduction prompt 40 via a user interface assembly 6 of the vehicle 2.

According to some embodiments, the outputted speed reduction prompt 40 may comprise the notification 4.

It will be appreciated that the various embodiments described for the method 100 are all combinable with the control arrangement 21 as described herein. That is, the control arrangement 21 may be configured to perform any one of the method steps 110, 115, 117, 120, 130, 131, 133, 134, 140, 141, 142, 144, 150, 152, and 153 of the method 100.

FIG. 4 illustrates a computer-readable medium 200 comprising instructions which, when executed by a computer, cause the computer to carry out the method 100 according to some embodiments of the present disclosure. According to some embodiments, the computer-readable medium 200 comprises a computer program comprising instructions which, when the program is executed by a computer, cause the computer to carry out the method 100 according to some embodiments. The computer may be comprised in the control arrangement 21.

One skilled in the art will appreciate that the method 100 of outputting a notification 4 in a driver environment 55 of a vehicle 2 may be implemented by programmed instructions. These programmed instructions are typically constituted by a computer program, which, when it is executed in the control arrangement 21, ensures that the control arrangement 21 carries out the desired control, such as the method steps 110, 115, 117, 120, 130, 131, 133, 134, 140, 141, 142, 144, 150, 152, and 153 described herein. The computer program is usually part of a computer program product which comprises a suitable digital storage medium on which the computer program is stored, such as the computer-readable medium 200 illustrated in FIG. 4. In other words, the computer program product may be a computer readable medium 200 and the computer program may be stored in the computer readable medium 200.

The control arrangement 21 may comprise a computer which may take the form of substantially any suitable type of hardware or hardware/firmware device implemented using processing circuity such as, but not limited to, a processor, Central Processing Unit (CPU), a controller, an arithmetic logic unit (ALU), a digital signal processor, an Application Specific Integrated Circuit (ASIC), a circuit for digital signal processing (digital signal processor, DSP), a microcomputer, a field programmable gate array (FPGA), a System-on-Chip (SoC), a programmable logic unit, a microprocessor, an application-specific integrated circuit, or any other device capable of electronically performing operations in a defined manner, or other processing logic that may interpret and execute instructions. The herein utilised expression “computer” may represent a processing circuitry comprising a plurality of processing circuits, such as, e.g., any, some or all of the ones mentioned above.

The control arrangement 21 may further comprise a memory unit, wherein the computer may be connected to the memory unit, which may provide the computer with, for example, stored program code and/or stored data which the computer may need to enable it to do calculations. The computer may also be adapted to store partial or final results of calculations in the memory unit. The memory unit may comprise a physical device utilised to store data or programs, i.e., sequences of instructions, on a temporary or permanent basis. According to some embodiments, the memory unit may comprise integrated circuits comprising silicon-based transistors. The memory unit may comprise e.g. a memory card, a flash memory, a USB memory, a hard disc, or another similar volatile or non-volatile storage unit for storing data such as e.g. ROM (Read-Only Memory), PROM (Programmable Read-Only Memory), EPROM (Erasable PROM), EEPROM (Electrically Erasable PROM), etc. in different embodiments.

The control arrangement 21 is connected to components of the vehicle 2 for receiving and/or sending input and output signals. These input and output signals may comprise waveforms, pulses, or other attributes which the input signal receiving devices can detect as information and which can be converted to signals processable by the control arrangement 21. These signals may then be supplied to the computer. One or more output signal sending devices may be arranged to convert calculation results from the computer to output signals for conveying to other parts of the vehicle's control system and/or the component or components for which the signals are intended. Each of the connections to the respective components of the vehicle 2 for receiving and sending input and output signals may take the form of one or more from among a cable, a data bus, e.g. a CAN (controller area network) bus, a MOST (media orientated systems transport) bus or some other bus configuration, or a wireless connection.

In the embodiments illustrated, the vehicle 2 comprises a control arrangement 21 but might alternatively be implemented wholly or partly in two or more control arrangements, two or more control arrangements, or two or more control units.

Control systems in modern vehicles generally comprise a communication bus system consisting of one or more communication buses for connecting a number of electronic control units (ECUs), or controllers, to various components on board the vehicle. Such a control system may comprise a large number of control units and taking care of a specific function may be shared between two or more of them. Vehicles and engines of the type here concerned are therefore often provided with significantly more control arrangements than depicted in FIG. 1, as one skilled in the art will surely appreciate.

The computer-readable medium 200 may be provided for instance in the form of a data carrier carrying computer program code for performing at least some of the method steps 110, 115, 117, 120, 130, 131, 133, 134, 140, 141, 142, 144, 150, 152, and 153 according to some embodiments of the method 100 when being loaded into one or more computers of the control arrangement 21. The data carrier may be, e.g. a CD ROM disc, as is illustrated in FIG. 4, or a ROM (read-only memory), a PROM (programable read-only memory), an EPROM (erasable PROM), a flash memory, an EEPROM (electrically erasable PROM), a hard disc, a memory stick, an optical storage device, a magnetic storage device or any other appropriate medium such as a disk or tape that may hold machine readable data in a non-transitory manner. Accordingly, in some embodiments, the computer-readable medium 200 may be a non-transitory computer-readable medium, such as a tangible electronic, magnetic, optical, infrared, electromagnetic, and/or semiconductor system, apparatus, and/or device. The computer-readable medium 200 may furthermore be provided as computer program code on a server and may be downloaded to the control arrangement 21 remotely, e.g., over an Internet or an intranet connection, or via other wired or wireless communication systems.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A method of outputting a notification in a driver environment of a vehicle, wherein the method is performed by a control arrangement, and wherein the vehicle comprises wheel brakes,
wherein the method comprises the steps of, when the vehicle is travelling on a road:
obtaining topographic data representative of the topography of an upcoming road segment of the road;
identifying an upcoming downhill slope in the upcoming road segment;
obtaining, based on the topographic data, a speed estimate representative of a maximum allowable speed of the vehicle upon reaching the upcoming downhill slope for keeping the speed of the vehicle below a threshold speed in the upcoming downhill slope while using a predetermined braking amount of the wheel brakes; and
outputting a notification indicating the speed estimate in the driver environment before the vehicle reaches the upcoming downhill slope.

2. The method according to claim 1, wherein the predetermined braking amount of the wheel brakes is set to limit at least one of wear of the wheel brakes and temperature development in the wheel brakes obtained in the upcoming downhill slope.

3. The method according to claim 1, wherein the vehicle comprises a wheel brake system comprising the wheel brakes, and wherein the vehicle comprises an additional system controllable to brake the vehicle, the additional system being separate from the wheel brake system, and wherein obtaining the speed estimate comprises:
obtaining the speed estimate based on an available braking power of the additional system.

4. The method according to claim 1, wherein obtaining the speed estimate comprises:
obtaining the speed estimate based on an inclination of the upcoming downhill slope.

5. The method according to claim 1, wherein obtaining the speed estimate comprises:
obtaining the speed estimate based on a length of the upcoming downhill slope.

6. The method according to claim 1, wherein the method comprises:
outputting the notification when the vehicle is a predetermined time or a predetermined distance from the upcoming downhill slope.

7. The method according to claim 6, wherein the method comprises:
adapting the predetermined time or the predetermined distance based on a difference between a current speed of the vehicle and the speed estimate.

8. The method according to claim 1, wherein the method comprises:
adapting the predetermined braking amount based on input from a user interface assembly of the vehicle.

9. The method according to claim 1, wherein the method comprises:
setting the threshold speed based on a regulatory speed limit of the upcoming downhill slope.

10. The method according to claim 1, wherein the method comprises:
reducing the speed of the vehicle to the maximum allowable speed before the vehicle reaches the upcoming downhill slope.

11. The method according to claim 10, wherein the method comprises:
generating a speed reduction prompt based on the speed estimate; and
outputting the speed reduction prompt in the driver environment of the vehicle, and
wherein reducing the speed of the vehicle is contingent upon receiving a confirmation of the speed reduction prompt via a user interface assembly of the vehicle.

12. The method according to claim 11, wherein the outputted speed reduction prompt comprises the notification.

13. A computer program product stored on a non-transitory computer-readable medium, said computer program product for outputting a notification in a driver environment of a vehicle, wherein the vehicle comprises wheel brakes, wherein said computer program product comprising computer instructions to cause one or more computer processors to perform the following operations:
when the vehicle is travelling on a road:
obtaining topographic data representative of the topography of an upcoming road segment of the road;
identifying an upcoming downhill slope in the upcoming road segment;
obtaining, based on the topographic data, a speed estimate representative of a maximum allowable speed of the vehicle upon reaching the upcoming downhill slope for keeping the speed of the vehicle below a threshold speed in the upcoming downhill slope while using a predetermined braking amount of the wheel brakes; and
outputting a notification indicating the speed estimate in the driver environment before the vehicle reaches the upcoming downhill slope.

14. (canceled)

15. A control arrangement configured to output a notification in a driver environment of a vehicle, wherein the vehicle comprises wheel brakes,
wherein the control arrangement is configured to, when the vehicle is travelling on a road:
obtain topographic data representative of the topography of an upcoming road segment of the road;
identify an upcoming downhill slope in the upcoming road segment;
obtain, based on the topographic data, a speed estimate representative of a maximum allowable speed of the vehicle upon reaching the upcoming downhill slope for keeping the speed of the vehicle below a threshold speed in the upcoming downhill slope while using a predetermined braking amount of the wheel brakes; and
output a notification indicating the speed estimate in the driver environment before the vehicle reaches the upcoming downhill slope.

16. A vehicle comprising wheel brakes and a control arrangement configured to output a notification in a driver environment of the vehicle, wherein the control arrangement is configured to, when the vehicle is travelling on a road:
obtain topographic data representative of the topography of an upcoming road segment of the road;
identify an upcoming downhill slope in the upcoming road segment;
obtain, based on the topographic data, a speed estimate representative of a maximum allowable speed of the vehicle upon reaching the upcoming downhill slope for keeping the speed of the vehicle below a threshold speed in the upcoming downhill slope while using a predetermined braking amount of the wheel brakes; and
output a notification indicating the speed estimate in the driver environment before the vehicle reaches the upcoming downhill slope.

17. The vehicle according to claim 16, wherein the vehicle is a heavy road vehicle.
